(19) United States
(12) Patent Application Publication
(10) Pub. No.: US 2025/0007340 A1
(43) Pub. Date: Jan. 2, 2025

(54) MAGNET DEVICE FOR AN ELECTRIC MACHINE

(71) Applicant: Rolls-Royce Deutschland Ltd & Co KG, Blankenfelde-Mahlow (DE)

(72) Inventors: Behnam Houshmand, München (DE); Adrian Levu, München (DE); Gunar Reinicke, Gauting (DE)

(21) Appl. No.: 18/694,942

(22) PCT Filed: Sep. 20, 2022
(86) PCT No.: PCT/EP2022/076055

§ 371 Date: Mar. 22, 2024

(30) Foreign Application Priority Data
Sep. 23, 2021 (DE) 10 2021 210 640.4

(51) Int. Cl. H02K 1/2793; H02K 15/03; H02K 16/02

(52) U.S. Cl. CPC H02K 1/2793; H02K 15/03; H02K 16/02

(57) ABSTRACT

The invention relates to a magnet device (1; 1′) for an electric machine (2) comprising: a support (10); 10′) with a flat support surface (100) and at least one form-fitting element (101); multiple magnets (11) arranged along the support surface (100) about an axis (A); and a holding part (12) which has at least one form-fitting element (120) which engages with the at least one form-fitting element (101) of the support (10; 10′) in a form-fitting manner and has a holding section (121) that is used to hold at least one of the magnets (11) on the support (10; 10′).

This application is the National Stage of International Application No. PCT/EP2022/076055, filed Sep. 20, 2022, which claims the benefit of German Patent Application No. DE 10 2021 210 640.4, filed Sep. 23, 2021. The entire contents of these documents are hereby incorporated herein by reference.

### BACKGROUND

The present disclosure relates to a magnet device for an electric machine and to a method for producing a magnet device.

In the case of electric motors and other electric machines, the aim is to continuously improve the target variables of energy efficiency, power-to-weight ratio, reliability, and service life. For low energy consumption in mobile applications (e.g., in vehicle construction), a low weight of the drives is also important. The requirements described apply, for example, to use in aircraft.

Electric machines regularly include a stator and a rotor that is rotatable relative thereto. In the case of permanently excited machines, permanent magnets are fastened to one of these two (e.g., to the rotor). Wire windings are mounted on the other component (e.g., on the stator). For motor operation, these may be acted upon with an alternating electrical field in order to generate a magnetic field that causes the rotor to rotate. The magnets of such a permanent magnet machine may be lighter than coils for the generation of comparable power, but the magnets still generally give the rotor a not insignificant weight.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, improved electric machines may be provided.

According to one aspect, a magnet device for an electric machine (e.g., an axial flow machine such as an axial flow motor) is indicated. The magnet device includes, for example, a disc-shaped carrier that has a flat support surface and at least one form-fit element. The magnet device further includes a number of magnets that are arranged along the support surface around an axis. The magnets may touch the support surface. A support portion and/or adhesive may further be arranged therebetween. The magnet device also includes a holding part with at least one form-fit element that is in form-fit engagement with the at least one form-fit element of the carrier. The holding part also has a holding portion by which one or more of the magnets are held on the carrier, for example, in a form-fitting manner.

For example, in the case of axial flow machines, an air gap is generally formed between the stator and the rotor in order to enable the rotation of the rotor. A distance that may also be referred to as a magnetic gap is also present between the windings and/or their iron cores (e.g., of the stator) and the magnets (e.g., of the rotor). The magnetic gap is at least as large as the air gap, but in practice is generally larger than the air gap. For example, the magnets may be arranged in a casing and fastened to a carrier of the rotor by this casing. The magnetic gap is thus larger than the air gap by at least the thickness of the casing. The described configuration makes it possible to dispense with such a casing. As a result of this, smaller magnets may be used, which enables a reduced weight of the electric machine. As a result of an improved magnetic coupling, improved performance of the electric machine with the magnet device is also enabled. Further, the stated casings are typically manufactured from composite materials that may often only be used in limited temperature ranges. As a result of the described configuration, such materials may be dispensed with, and higher temperatures of use may be enabled.

The stated axis corresponds, for example, to the axis of rotation of the electric machine with the magnet device.

The magnets may have a bevel. The holding portion of the holding part optionally bears against the bevel of the at least one magnet (e.g., in a flat manner). This enables secure retention and simple mounting. The magnets and the holding part may have surfaces that all lie in one plane. Such a configuration may be enabled, for example, by the bevel. The air gap may be kept particularly small as a result of the common surface.

The holding part may be formed to be annular. The holding part extends, for example, around the axis. This enables a particularly robust configuration. The holding part is manufactured, for example, from metal.

The magnet device further includes, for example, a holder with a holding portion, by which the one or more of the magnets are held on the carrier (e.g., on a side), directed away from the holding portion of the holding part, of each of the one or more magnets. This enables particularly easy mounting. For example, for this purpose, the magnets are first pushed under the holding portion of the holder and then fixed with the holding part. The holding portion of the holding part and/or the holding portion of the holder may form, in each case, an angled interface for the magnets 11. For example, the holding portion of the holding part and/or the holding portion of the holder tapers (e.g., as viewed in cross-section). The holder may be fixed on the carrier (e.g., fastened thereon).

In one configuration, the holder is formed on the carrier (e.g., connected in one piece to the carrier). As a result of this, it is possible to achieve a small number of parts. A particularly robust configuration is thus furthermore possible.

According to one alternative configuration, the holder is formed on a support body that represents a component that is separate from the carrier and may be mounted (or is mounted) on the carrier. The support body has, for example, a support portion that is arranged between the one or more magnets and the carrier. The magnets bear, for example, flat against the support portion. The magnets may thus first be mounted on the support body and then be mounted on the carrier as a prefabricated structural unit. This enables particularly easy mounting of the magnets and high precision in manufacture.

The magnets are optionally arranged in a row (e.g., annularly). For example, the magnets are formed in the form of a segmented magnet ring. Further, the magnets may be arranged, for example, in two or more rows (e.g., in each case, annularly), between which the holder may be arranged. As a result of this, a particularly high-performance electric machine is possible.

The magnet device may also include a further holding part. The further holding part has, for example, at least one form-fit element that is in form-fit engagement with at least one further form-fit element of the carrier and/or a holding portion by which the one or more magnets are held on the carrier. At least one of the magnets may be arranged between the holding part and the further holding part. For example, two rows of magnets are provided, one row between the holding part and the holder and a further row between the holder and the further holding part. The holder may be arranged between the two rows.

The form-fit element of the carrier and the form-fit element of the holding part may jointly form a bayonet connection. This enables particularly rapid and secure mounting. During mounting, the holding part may therefore be pushed, for example, first axially onto the carrier, and is then rotatable about the axis for locking with the carrier on the carrier. The further form-fit element of the carrier and the form-fit element of the further holding part may jointly form a bayonet connection.

The magnets may have in each case an outer surface that is directed away from the carrier, where the outer surfaces of the magnets lie in the same plane (e.g., extended in two spatial directions). This plane is oriented, for example, perpendicular to the above-mentioned axis. The holding portion of the holding part and/or the holding portion of the holder border, for example, these outer surfaces.

The magnets are, for example, permanent magnets. This enables use in a permanently excited electric machine.

According to one aspect, a rotor for an electric machine is indicated. The rotor includes the magnet device according to any configuration described herein. In terms of the advantages, reference is made to the above information relating to the magnet device.

According to one aspect, an electric machine is indicated (e.g., a motor, such as an axial flow machine or axial flow motor). The electric machine includes a stator and the rotor described above, or a rotor, a stator, and the magnet device according to any configuration described herein. In terms of the advantages, reference is made to the above information relating to the magnet device.

The magnet device may form, for example, a part of the rotor.

According to one aspect, a method for producing a magnet device (e.g., the magnet device according to any configuration described herein) is indicated. The method includes providing a carrier with a flat support surface and at least one form-fit element and the arrangement of several magnets along the support surface around an axis and the form-fitting connection of at least one form-fit element of a holding part to the at least one form-fit element of the carrier. At least one of the magnets is held by a holding portion of the holding part on the carrier. In terms of the advantages, reference is made to the above information relating to the magnet device.

The method may further include, prior to the arrangement of the magnets along the support surface, the assembly of a cassette by arranging the magnets and the holding part, and optionally a further holding part, on a support body. The magnets are then arranged around the axis by mounting the support body on the support surface of the carrier along the support surface.

### BRIEF DESCRIPTION OF THE DRAWINGS

Exemplary embodiments will now be described with reference to the figures, in which:

FIG. 1 shows a schematic representation of an electric machine with a stator and two rotors;

FIGS. 2A-2D show acts in the production of a magnet device of the electric machine according to FIG. 1 with a carrier, a number of magnets, and two holding parts for the magnets;

FIGS. 3A-3D show acts in the production of a cassette of a magnet device for the electric machine according to FIG. 1 with a support body, a number of magnets, and two holding parts for the magnets;

FIGS. 4A and 4B show acts in the production of a magnet device for the electric machine according to FIG. 1 with a carrier and the cassette according to FIG. 3D;

FIG. 5 shows an optional stop for one of the holding parts;

FIG. 6 shows a detailed view of a cross-section of the magnet device according to FIG. 4B; and

FIG. 7 shows an aircraft with a number of electric machines according to FIG. 1 for driving a number of propellers.

### DETAILED DESCRIPTION OF THE DRAWINGS

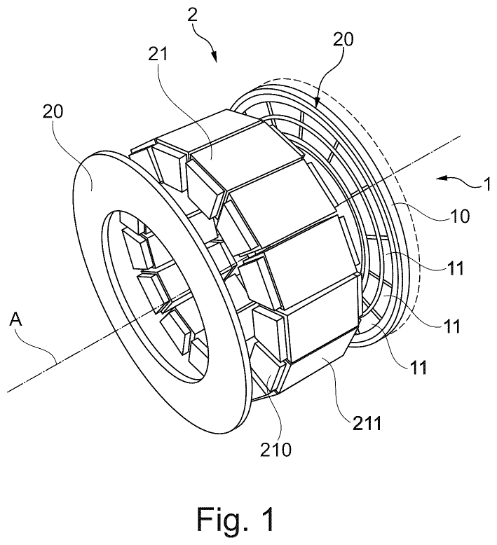

FIG. 1 shows an electric machine 2 in the form of an axial flow motor (or transversal flow motor). The electric machine 2 includes a stator 21 and in general at least one rotor 20 that is rotatable about an axis A relative to the stator 21. In the example shown, the electric machine 2 includes two rotors 20, of which, however, one is optional. Each of the rotors 20 is rotatable relative to the stator 21 (e.g., in the present case, about the same axis A). The rotors 20 may represent sub-rotors of a rotor. The electric machine 2 may include a number of stators 21 and respectively associated rotors 20 that are formed in each case, for example, according to FIG. 1 and are oriented, for example, coaxially to the axis A.

The rotors 20 include in each case a magnet device 1 with a number of magnets 11 (e.g., in the form of permanent magnets). The respective magnet device 1 also include a carrier 10 to which the magnets 11 are fastened in a manner explained in greater detail further below. Each of the rotors 20 may include further components, as indicated in FIG. 1 in the case of one of the rotors 20.

The carrier 10 of each of the rotors 20 is disc-shaped. Each of the rotors 20 is arranged along the axis A next to the stator 21. FIG. 1 shows the electric machine 2 in an exploded representation, but a distance is also formed in the assembled state between the stator 21 and each of the rotors 20 in the axial direction (e.g., along the axis A). As a result of this distance, an air gap is present between the stator 21 and the respective rotor 20 in the axial direction. The electric machine 2 therefore has an axial air gap between the stator 21 and the (respective) rotor 20.

The carrier 10 of each of the rotors 20 forms a support surface that is oriented perpendicular to the axis A. The magnets 11 of the respective rotors 20 are arranged along this support surface around the axis A. In the present case, the magnets 11 are arranged concentrically to the axis A.

The stator 21 is arranged between the two rotors 20.

The stator 21 includes a stator core 210 and a stator winding 211. The magnets 11 and the stator winding 211 extend at the same radial distance to the axis A. The stator winding 211 may be acted upon with electric current (e.g., an alternating current, such as a three-phase alternating current). As a result of this, a magnetic rotating field, by which a force is exerted on the magnets 11 that brings about a rotation of the respective rotor 20 relative to the stator 21 around the axis A is generated. The magnetic fields act in the axial direction in this case.

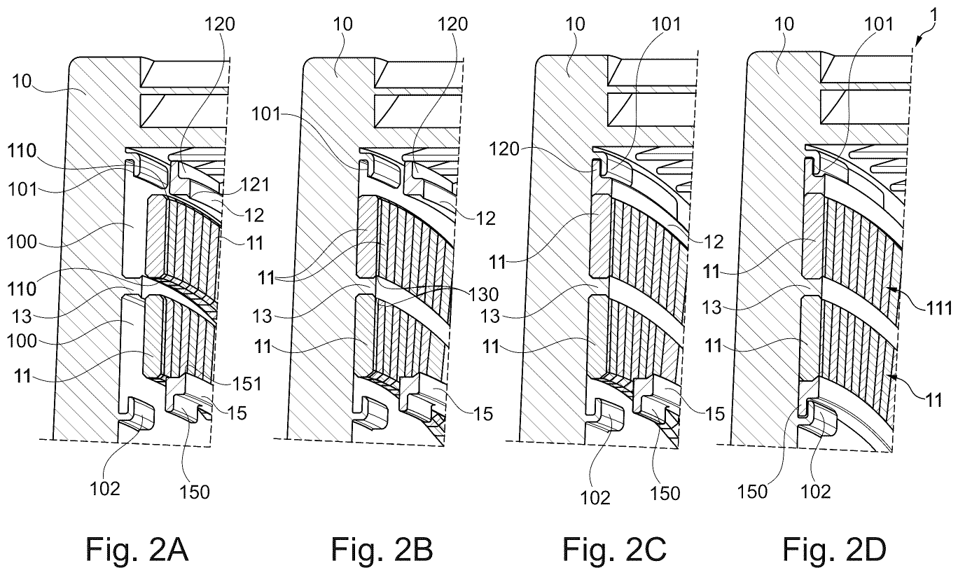

FIGS. 2A to 2D illustrate a method for producing the magnet device 1 (e.g., of one rotor 20 and in an analogous manner to this of the other rotor 20 of the electric machine 1 according to FIG. 1).

The carrier 10, the magnets 11, and two holding parts 12, 15 are initially provided.

The carrier 10 forms two annular, flat support surfaces 100, in each case one for an annular row of magnets 11. The support surfaces 100 extend in the same plane, and a smaller of the support surfaces 100 is surrounded on the outside by a larger of the support surfaces 100. The carrier 10 further forms a number of form-fit elements 101, 102. In the present case, each of the form-fit elements 101, 102 has a projection. The form-fit elements 101, 102 are formed and arranged to enter into a form-fit. The form-fit elements 101, 102 have an L-shaped cross-section here. The form-fit elements 101, 102 form in each case a receptacle. The form-fit elements 101, 102 are formed in each case at the edge of one of the support surfaces 100. The receptacles of the form-fit elements 101, 102 are opened toward the respectively adjoining support surface 100. A gap is formed between at least two form-fit elements 101, 102 arranged offset to one another in the circumferential direction around the axis A (and at the same radial distance to the axis A). In the example shown, form-fit elements 101 are formed at the outer edge of the outer support surface 100, and further form-fit elements 102 are formed at the inner edge of the inner support surface 100. The carrier 10 also includes a holder 13. The holder 13 is connected in one piece to the other carrier 10. The holder 13 is annular and extends around the axis A. The holder 13 is arranged between the two support surfaces 100. The holder 13 has two holding portions 130, a radially inner one and a radially outer one. It is apparent in cross-section that the holding portions 130 project from the holder 13 at a free end of the holder 13, and in the present case, in a direction perpendicular to the axis A. The holding portions 130 have in each case a chamfer.

The magnets 11 have in each case a bevel 110 on two opposite sides. An outer surface 111 extends between the two bevels 110.

The holding parts 12, 15 are formed in each case in an annular manner (and in the present case, respectively, as a closed ring). A radially outer holding part 12 has form-fit elements 120 that, in the example shown, project radially outwardly from the holding part 12. The form-fit elements 120 are formed in the form of lugs. The holding part 12 also has a holding portion 121 that projects radially inward. The holding portion 121 has a chamfer. A radially inner holding part 15 has form-fit elements 150 that, in the example shown, project radially inwardly from the holding part 15. The form-fit elements 150 are formed in the form of lugs. The holding part 15 also has a holding portion 151 that projects radially outward. The holding portion 151 has a chamfer.

In a first mounting act (see, e.g., FIGS. 2A and 2B), the magnets 11 are arranged on the support surfaces 100. For this purpose, they are brought into engagement with the respective holding portion 130 of the holder 13. The holding portion 130 then engages over the respective magnets 11. In concrete terms, the chamfer of the respective holding portion 130 bears flat with the bevel 110 of the respective magnets 11. An adhesive that holds the magnets 11, after mounting on the carrier 10, adhesively thereon is additionally applied to the support surfaces 100 and/or to the magnets 11.

The magnets 11 glued to the carrier 10 and in form-fitting engagement with the holder 13 are shown in FIG. 2B.

FIG. 2C illustrates the mounting of the outer holding part 12. The outer holding part 12 is placed onto the carrier 10 (e.g., pushed thereon along the axis A), where the form-fit elements 120 of the holding part 12 engage in each case in a gap between two form-fit elements 101 of the carrier 10. The holding part 12 is then rotated around the axis A so that the form-fit elements 120 of the holding part 12 engage in the receptacles of the form-fit elements 101 of the carrier 10. As a result of this, the holding part 12 is held in a form-fitting manner on the carrier 10. The holding part 12 and the carrier 10 thus form a bayonet connection. In the mounted state, the holding portion 121 of the holding part 12 also bears flat with the bevel 110, directed toward the holding part 12, of the magnets 11. As a result of this, the magnets 11 of the outer row between the holding part 12 and the holder 13 are held in a form-fitting manner on the carrier 10.

FIG. 2D illustrates the mounting of the inner holding part 15 that is performed in an analogous manner to the mounting of the outer holding part: The inner holding part 15 is also placed onto the carrier 10, where the form-fit elements 150 of the holding part 15 engage in each case in a gap between two form-fit elements 102 of the carrier 10. The holding part 15 is then rotated around the axis A so that the form-fit elements 150 of the holding part 15 engage in the receptacles of the form-fit elements 102 of the carrier 10. As a result of this, the holding part 15 is held in a form-fitting manner on the carrier 10. The holding part 15 and the carrier 10 likewise form a bayonet connection. In the mounted state, the holding portion 151 of the holding part 15 also bear flat with the bevel 110, directed toward the holding part 15, of the magnets 11. As a result of this, the magnets 11 of the inner row between the holding part 15 and the holder 13 are held in a form-fitting manner on the carrier 10.

FIG. 2D shows the fully mounted magnet device 1. Since no casings or the like are necessary for the magnets 11, it is possible to design the structural air gap of the electric machine 2 to be particularly narrow. The mechanical gap and the magnetic gap may be identical in this case. As a result of this, the magnet weight may be reduced and/or the performance of the electric machine may be improved. Improved heat discharge may also be possible.

The carrier 10 is composed of at least one metal or includes at least one metal. For example, the carrier is composed of steel. The holding parts 12, 15 are likewise composed of at least one metal and include at least one metal. For example, the holding parts 12, 15 are composed of steel. Particularly robust components that, for example, also have a long service life and predictable aging may be produced from metals. For example, the magnet device 1 (or even the rotor 20) is free of composite materials, the aging of which is often difficult to predict.

The magnet device 1 may also have, instead of two rings of magnets 11 and two holding parts 12, 15, only one of the rings of magnets 11 and one of the holding parts 12, 15.

According to FIGS. 2A to 2D, the magnets 11 bear directly against the carrier 10. The magnets 11 touch the carrier 10 and/or are glued thereto by the adhesive. Instead of an adhesive or in addition to the adhesive, at least one stop may be provided on the carrier 10 on which at least one magnet 11 stops in the circumferential direction.

In the case of the magnet device 1, the magnets 11 are secured in all directions against a movement relative to the carrier 10. The magnets 11 may introduce a torque about the axis A into the other rotor 20.

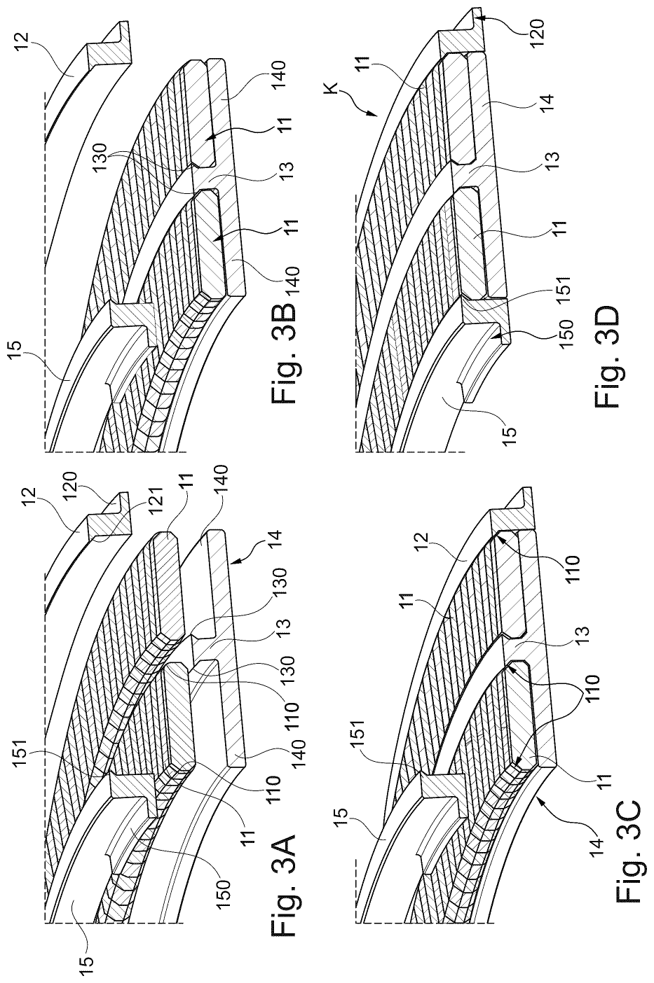

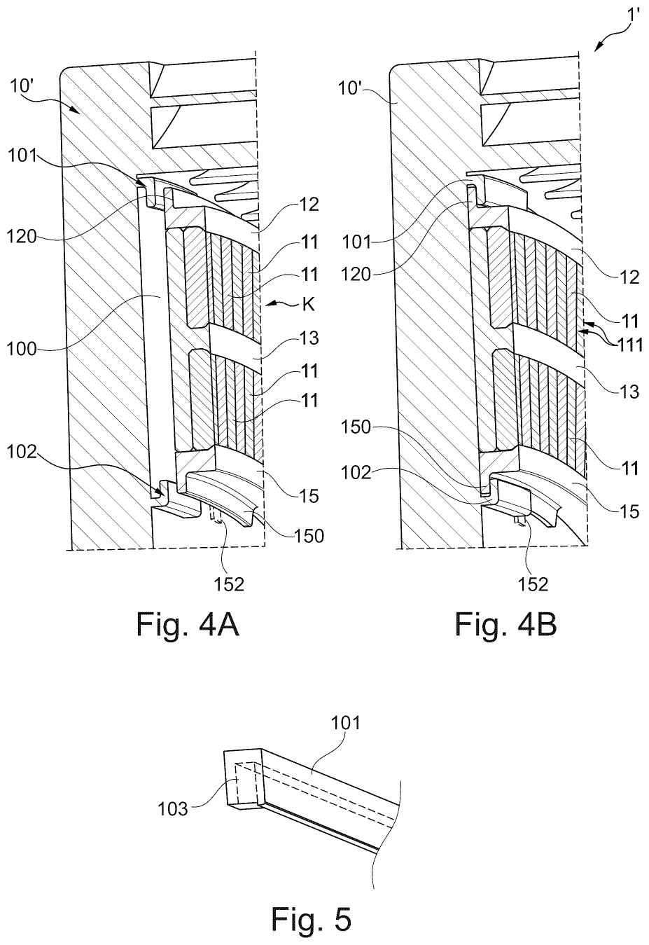

Alternatively, a magnet device 1′ may be produced as illustrated based on FIGS. 3A to 4B. In this case, the holder 13 is not formed on the carrier 10, but rather on a support body 14 that may be mounted thereon. This enables particularly precise manufacture. It is also possible to provide, for example, only one ring of magnets 11. In this case, no holder 13 is required, or the holder 13 is provided on the carrier 10.

The support body 14 has a support portion 140 for each segmented ring of magnets 11. Each support portion 140 is annular. The support portions 140 form in each case a bearing surface for the magnets 11. The bearing surface of each support portion 140 is flat.

The holder 13 is arranged between the two support portions 140. The magnets 11 are initially arranged on the support portions 140 and brought into engagement with the respective holding portion 130 of the holder 13. The magnets 11 are also glued to the support portions 140 (optionally) by adhesive. Thereafter, the two holding parts 12, 15 are arranged on both sides of the magnets 11. It may be provided in this case that the holding parts 12, 15 are dimensioned so that the holding parts 12, 15 are pressed in a force-fitting manner onto the magnets 11 and/or in a force-fitting manner onto the support body 14. The magnets 11 and the support body 14 are then arranged between the holding parts (see FIG. 3D), so that a cassette K is formed. In this case, the magnets 11 are held in a form-fitting manner between the holder 13 and the respective holding part 12, 15 in a manner corresponding to the magnet device 1 according to FIGS. 2A to 2D.

As illustrated based on FIG. 4A, the cassette K is then mounted on the carrier 10′, and due to the fact that the cassette K is placed on the support surface 100 of the carrier 100, the form-fit elements 120, 150 of the holding parts 12, 15 are incorporated into gaps between the form-fit elements 101, 102 of the carrier 10′. The cassette K is then rotated about the axis A relative to the carrier 10′, so that the form-fit elements 120, 150, 101, 102 come into engagement and hold the cassette K along with the magnet 11 in a form-fitting manner on the carrier 10′.

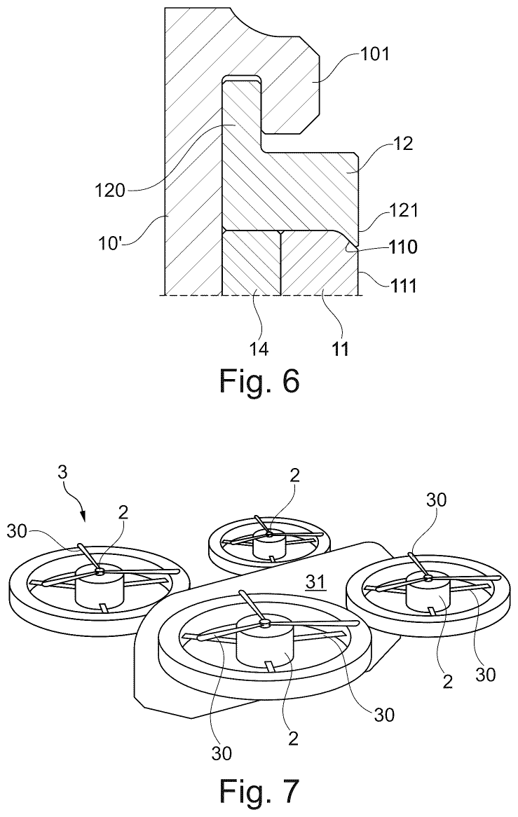

For example, based on FIG. 6, the form-fit element 101 of the carrier 10′ engages over the form-fit element 120 of the holding part 12. The holding portion 121 of the holding part 12 engages over the adjoining magnet 11 (e.g., bears against the bevel 110 thereof). The support body 14 is arranged between the carrier 10′ and the magnet 11.

Based on FIGS. 2D, 4B, and 6, the outer surfaces 111 (e.g., directed toward the stator 21 in the electric machine 2) of the magnets 11 all lie in one plane. The outer surfaces (e.g., directed toward the stator 21 in the electric machine 2) of the holding parts 12, 15 also lie in this plane.

An optional stop 152 projects on one or more of the form-fit elements 101, 102, 120, 150 (e.g. as shown in the radial direction). By way of example, such a stop 152 on a form-fit element 150 of the inner holding part 15 is illustrated in FIGS. 4A and 4B. This stop 152 stops in a position, held in a form-fitting manner against a movement in the direction of the axis A away from the carrier 10′, of the holding part 15 laterally on the respective form-fit element 102 of the carrier 10′, and thus prevents further rotation. Depending on the preferred direction of the electric machine 2, it may be provided that the bayonet connection locks in one or the other direction of rotation. In general, the locking direction may depend on the preferred direction (e.g., the main direction of rotation) of the electric machine 2, for example, be oriented in an opposite direction thereto.

FIG. 5 shows, by way of example, a stop 103 on a form-fit element 101 of the carrier 10′ for a corresponding form-fit element of the holding part 12. This stop 103 laterally closes the receptacle of the form-fit element 102 of the carrier 10′. As an alternative to a stop or in addition to this, a force-fitting fixing of the holding parts 12, 15 in the mounted position may be secured against a rotation relative to the carrier 10′. The holding parts 12, 15 may also be fixed on the carrier 10′ for this purpose in another manner (e.g., are screwed thereto).

FIG. 7 shows an aircraft 3 in the form of an air taxi. The aircraft 3 includes a cabin and a number of electric machines 2 according to FIG. 1 as an electric motor. Each of the electric machines 2 drives two propellers 30. For this purpose, each of the propellers is operatively connected to one of the rotors 20 of the electric machine 2 (e.g., fastened thereto). A battery 31 supplies electric current for operation of the electric machines 2. The electric machines 2 involve direct drives.

It will be understood that the invention is not limited to the above-described embodiments, and different modifications and improvements may be carried out without deviating from the concepts described here. Any of the features may be used separately or in combination with any other features, unless they are mutually exclusive, and the disclosure extends to and includes all combinations and subcombinations of one or more features that are described herein.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A magnet device for an electric machine,
the magnet device comprising:
a carrier with a flat support surface and at least one form-fit element;
a number of magnets arranged along the flat support surface around an axis; and
a holding part with at least one form-fit element that is in form-fitting engagement with the at least one form-fit element of the carrier and has a holding portion by which at least one of the number of magnets is held on the carrier.

2. The magnet device of claim 1, wherein the number of magnets have a bevel, and the holding portion of the holding part bears flat against the bevel of the at least one magnet.

3. The magnet arrangement of claim 1, wherein the holding part is formed in an annular manner.

4. The magnet device of claim 1, further comprising a holder with a holding portion by which the at least one magnet is held on a side, directed away from the holding portion of the holding part, of the at least one magnet on the.

5. The magnet device of claim 1, wherein the holder is formed on the carrier.

6. The magnet device of claim 1, wherein the holder is formed on a support body that has a support portion that is arranged between the at least one magnet and the carrier.

7. The magnet device of claim 4, wherein the number of magnets are arranged in two rings, between which the holder is arranged.

8. The magnet device of claim 1, further comprising a further holding part with at least one form-fit element that is in form-fitting engagement with at least one further form-fit element of the carrier and has a holding portion by which at least one of the number of magnets is held on the carrier,
wherein one or more magnets of the number of magnets are arranged between the holding part and the further holding part.

9. The magnet device of claim 1, wherein the at least one form-fit element of the carrier and the at least one form-fit element of the holding part jointly form a bayonet connection.

10. The magnet device of claim 1, wherein the number of magnets have in each case an outer surface directed away from the carrier,
wherein the outer surfaces of the number of magnets lie in a same plane.

11. The magnet device of claim 1, wherein the number of magnets are permanent magnets.

12. A rotor for an electric machine, the rotor comprising:
a magnet device for the electric machine, the magnet device comprising:
a carrier with a flat support surface and at least one form-fit element;
a number of magnets arranged along the flat support surface around an axis; and
a holding part with at least one form-fit element that is in form-fitting engagement with the at least one form-fit element of the carrier and has a holding portion by which at least one of the number of magnets is held on the carrier.

13. An electric machine comprising:
a rotor;
a stator; and
a magnet device comprising:
a carrier with a flat support surface and at least one form-fit element;
a number of magnets arranged along the flat support surface around an axis; and
a holding part with at least one form-fit element that is in form-fitting engagement with the at least one form-fit element of the carrier and has a holding portion by which at least one of the number of magnets is held on the carrier.

14. The electric machine of claim 13, wherein the magnet device forms a part of the rotor.

15. A method for producing a magnet device, the method comprising:
providing a carrier with a flat support surface and at least one form-fit element; and
arranging a number of magnets along the flat support surface around an axis; and
form-fitting connection of at least one form-fit element of a holding part to the at least one form-fit element of the carrier,
wherein at least one of the number of magnets is held by a holding portion of the holding part on the carrier.

16. The method of claim 15, further comprising, prior to the arranging of the number of magnets along the support flat surface:
assembling a cassette, the assembling of the cassette comprising arranging the number of magnets, the holding part, and a further holding part on a support body.
